(19) United States
(12) Patent Application Publication
(10) Pub. No.: US 2008/0177979 A1
(43) Pub. Date: Jul. 24, 2008

(54) HARDWARE MULTI-CORE PROCESSOR OPTIMIZED FOR OBJECT ORIENTED COMPUTING

(76) Inventors: GHEORGHE STEFAN, Bucharest (RO); MARIUS-CIPRIAN STOIAN, Vrancea (RO)

Correspondence Address: MCCORMICK, PAULDING & HUBER LLP, CITY PLACE II, 185 ASYLUM STREET, HARTFORD, CT, 06103, US

(21) Appl. No.: 12/057,813

(22) Filed: Mar. 28, 2008

Related U.S. Application Data
(63) Continuation-in-part of application No. 11/365,723, filed on Mar. 1, 2006, now abandoned.

(51) Int. Cl. G06F 15/76; G06F 9/02

(52) U.S. Cl. 712/28; 712/E09.002

(57) ABSTRACT

A multi-core processor system includes a context area, which contains an array of stack core processing elements, a storage area that contains expensive shared resources (e.g., object cache, stack cache, and interpretation resources), and an execution area, which contains complex execution units such as an FPU and a multiply unit. The execution resources of the execution area, and the storage resources of the storage area, are shared among all the stack cores through one or more interconnection networks. Each stack core contains only frequently used resources, such as fetch, decode, context management, an internal execution unit for integer operations (except multiply and divide), and a branch unit. By separating the complex and infrequently used units (e.g., FPU or multiply/divide unit) from the simple and frequently used units in a stack core, all the complex execution resources are shared among all the stack cores, improving efficiency and processor performance.

### CROSS REFERENCE TO RELATED APPLICATIONS

This application is a continuation-in-part of, and claims priority to, U.S. patent application Ser. No. 11/365,723 entitled “HIGHLY SCALABLE MIMD MACHINE FOR JAVA AND .NET PROCESSING,” filed on Mar. 1, 2006, which is herein incorporated by reference in its entirety.

### FIELD OF THE INVENTION

The present invention relates to computer microprocessor architecture.

### BACKGROUND OF THE INVENTION

In many commercial computing applications, most of a microprocessor's hardware resources remain unused during computations. For resources occupying a relatively small area, the impact of these unused resources can be neglected, but a low degree of utilization for large and expensive resources (like caches or complex execution units, e.g., a floating point unit) results in an overall inefficiency for the entire processor.

Sharing as many resources as possible on a processor can increase the overall efficiency, and therefore performance, considerably. For example, it is known that the cache in a processor can comprise more than 50% of the total area of the chip. If by increasing the degree to which cache resources are shared, the utilization degree of the cache doubles, the processor will run with the same performance as when the cache is doubled in size. By sharing the caches and all the complex execution units among the processing elements in a microprocessor, an important increase of the utilization degree (which means an increase of the overall performance) is expected.

The proliferation of OOL (object-oriented languages) and the associated software architectures can be used to deliver a hardware architecture allowing the sharing of these expensive resources, hence greatly improving performance and reducing the overall size of processor.

The main advantage of using a pure OOL instruction set is the virtualization of the hardware resources. Therefore, using a platform-independent object oriented instruction set like Java™ or .Net™ enables the same architecture to be scaled into a large range of products that can run on top of the same applications (with different performances, depending on the allocated resources). For example, the fact that the Java™ Virtual Machine Specification uses a stack instead of a register file allows the hardware resources allocated for the operands stack to be scaled, depending on the performances/costs of the target products. Therefore, the Java™/.Net™ instruction set offers another layer of scalability. While OOL helps in maximizing the use of expensive resources, the processor architecture described herein provides improvements to non-Object Oriented Languages (non-OOL) when a software compiler is used.

### SUMMARY OF THE INVENTION

An embodiment of the present invention relates to a computing multi-core system that incorporates a technique to share both execution resources and storage resources among multiple processing elements, and, in the context of a pure object oriented language (OOL) instruction set (e.g. Java™, .Net™, etc.), a technique for sharing interpretation resources. (As should be appreciated, prior art machines and systems utilize multiple processing elements, with each processing element containing individual execution resources and storage resources). The present invention can also offer performance improvement in the context of other non pure OOL instruction sets (e.g. C/C++), due to the sharing of the storage and execution resources.

Usually, a multi-core machine contains multiple processing elements and multiple shared resources. The system of the present invention, however, utilizes a specific way to interconnect and to segregate the simple processing elements from the complex shared resources in order to obtain the maximum of performance and flexibility. An additional increase in flexibility is given by the implementation of the pure OOL instruction set. A pure object oriented language is a language in which the concepts of encapsulation, polymorphism, and inheritance are fully supported. In a pure OOL, every piece of object-oriented code must be part of a class, and there are no global variables. Therefore, Java™ and .Net™, as opposed to C++, are pure OOLs. On the physical structure of the system disclosed herein, non-pure OOLs like C/C++ or any other code can also be executed when using an appropriate compiler. For example, the processor system can be optimally applied for Java™ and/or .Net™ because support from the Java™/.Net™ compiler already exists.

A pure OOL processor directly executes most of the pure OOL instructions using hardware resources. A multi-core machine is able to process multiple instructions streams that can be easily associated with threads at the software level. Each processing element or entity from the multi-core machine contains only frequently used resources: fetch, decode, context management, an internal execution unit for the integer operations (except multiply and divide), and a branch unit. By separating the complex and infrequently used units (e.g., floating point unit or multiply/divide unit) from the simple and frequently used units in a processing element (e.g. integer unit), we are able to share all the complex execution resources among all the processing elements, hence defining a new CPU architecture. If necessary for further reducing power consumption, the complex execution units can be omitted and replaced by software interpreters. The new processing entities, which do not contain any complex execution resources, are referred to herein as “stack cores.”

Depending on the application running, the processor system can be scaled with a very fine grain in terms of: the number of stack cores (which depends on the degree of parallelism of the running application); the number (and type) of the specific execution units (which depends on the type of the computation required by the application) (e.g., integer type, floating point type); cache size (which depends on the target performances); and stack cache size (which depends on target levels of performance).

While the hardware structure presented in this invention is optimized for OOL (object oriented languages), it can also execute a non-pure OOL by using a suitable compiler and still deliver performance improvements as compared to current processor architectures. As noted above, two examples of pure OOLs used in this implementation are the Java™/.Net™ instruction set. Java™/.Net™ instruction sets can be used both independently or combined, but the present invention is not limited to Java™/.Net™. While this invention optimizes the execution of OOL code natively, it also can execute code written in any programming language when a proper compiler is used.

Additionally, the optimal execution of pure OOLs is achieved by using two specific types of caches. The two caches are named the object cache and the stack cache. The object cache stores entire objects or parts of objects. The object cache is designed to pre-fetch parts or entire objects, therefore optimizing the probability of an object to be already resident in the cache memory, hence further speeding up the processing of code. The stack cache is a high-speed internal buffer expanding the internal stack capacity of the stack core, further increasing the efficiency of the invention. In addition, the stack cache is used to pre-fetch (in background) stack elements from the main memory. By combining the stack cores, object cache, and stack cache, this invention delivers increased efficiency in OOL applications, without affecting non-OOL programs and applications.

In another embodiment, resources are shared using two interconnect networks, each of which implements a priority based mechanism. Using these two interconnect networks, the machine achieves two important goals, namely, scalability in terms of the number of stack cores in the processing system, and scalability in the number and type of the specific execution units.

In another embodiment, the stack cores execute the most frequently seen pure OOL bytecodes in hardware, a few infrequently used bytecodes are interpreted by the interpretation resources, and a small number of object allocation instructions are trapped and executed with software routines. This approach is opposed to a pure OOL virtual machine (like Java VM™) that interprets bytecodes through the host processor's instructions. Another approach to pure OOL execution is to choose a translation unit, which substitutes the switch statement of a pure OOL virtual machine interpreter (bytecode decoding) through hardware, and/or translates simple bytecodes to a sequence of RISC instructions on the fly.

The performance of the stack cores is scaled using Amdahl's Law. Amdahl's Law states that the speedup of a particular instruction or set of instructions that is/are infrequently used generates a small impact on the global performance. In the processing system of the present invention, the impact of hardware/trapped execution was measured and a trade-off between speed/area/power consumption has been made.

### BRIEF DESCRIPTION OF THE DRAWINGS AND TABLES

The present invention will be better understood from reading the following description of non-limiting embodiments, with reference to the attached drawings, wherein below:

FIG. 1 is a block diagram of a pure OOL (object-oriented language) processing engine using a multi-core based machine, according to an embodiment of the present invention;

FIG. 2 is a block diagram of a stack core;

FIG. 3 is a block diagram of an object cache unit;

FIG. 4 is a block diagram of a stack cache unit;

FIG. 5 is a simplified block diagram of a priority management mechanism for a thread synchronization unit;

FIG. 6 is a diagram that represents the mode of operation in the case of a generic memory bank request;

FIG. 7 is a diagram that represents the mode of operation in the case of a pure OOL instruction that calls a method (e.g., the case of the invokevirtual bytecode in Java™);

FIG. 8 is a flow chart showing operation of an object cache unit;

FIG. 9 is a flow chart explaining the execution of an invokevirtual instruction; and

FIG. 10 is a diagram of an object record structure in a heap area.

### DETAILED DESCRIPTION OF THE PREFERRED EMBODIMENT

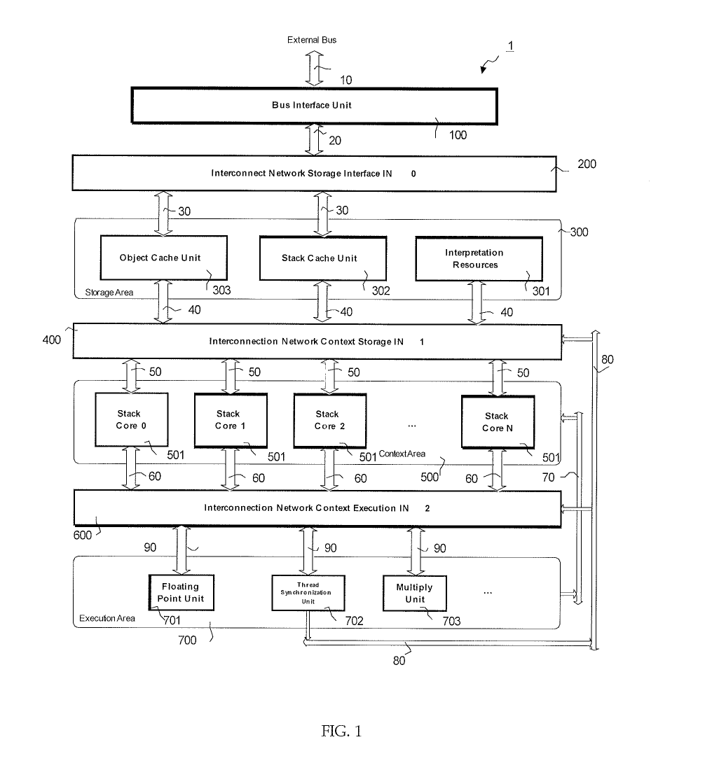

FIG. 1 shows a computing system 1 that includes multiple stack cores 501 (e.g., stack core 0 to stack core “N”) and multiple shared resources, according to an embodiment of the present invention. Each stack core 501 contains hardware resources for fetch, decode, context storage, an internal execution unit for integer operations (except multiply and divide), and a branch unit. Each stack core 501 is used to process a single instruction stream. In the following description, “instruction stream” refers to a software thread.

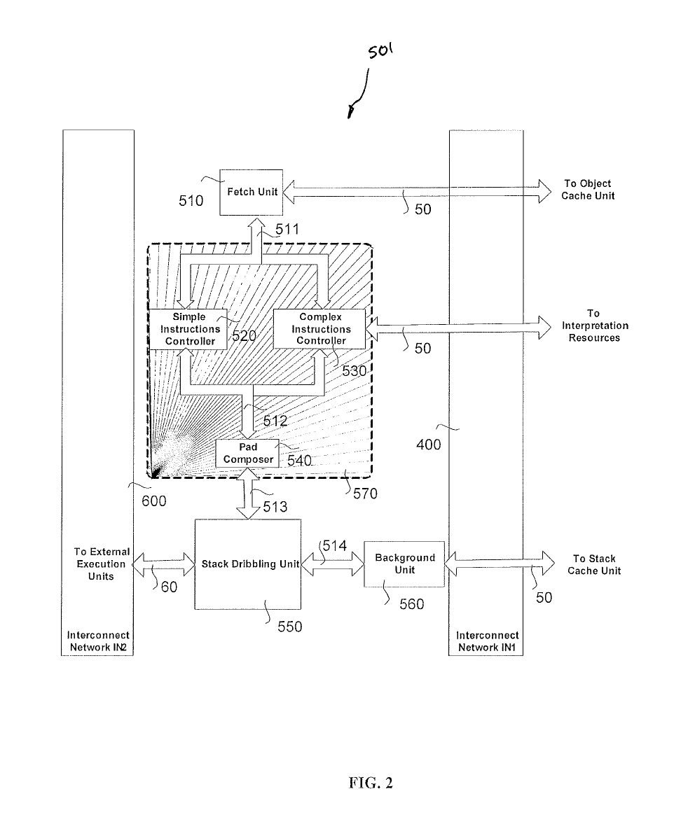

The computing system shown in FIG. 1 may appear geometrically similar to the thread slot and register set architecture shown in FIG. 2(a) in U.S. Pat. No. 5,430,851 to Hirata et al. (hereinafter, “Hirata”). However, the stack cores 501 are fundamentally different, in that: (i) the control structure and local data store are merged in the stack core 501; (ii) the internal functionality of the stack core is strongly language (e.g., Java™/.Net™) oriented; and (iii) this advanced merge between control and data is specific, and thus mandatory for an object oriented (e.g., Java™/.Net™) machine. In Hirata's approach, the thread-associated structure (e.g., thread slot) refers only to a part of the control section: Instruction Fetch, Program Counter, and Decode Unit. None of the problems related with the branch control or integer execution, for example, are addressed. Another primary difference results from the multiple caches in the system in Hirata (e.g., each thread has its own cache memory) versus the unified cache in the system of the present invention. This is considered to be a key difference between the present invention and the system in Hirata. This is because the cache memory is the most expensive physical resource of a processor (more than 50% of the area is used by this subsystem in a standard approach).

Another hardware object oriented virtual machine is disclosed in detail in Mukesh K. Patel et al.'s “Java virtual machine hardware for RISC and CISC processors” (hereinafter, “Patel”). Patel, however, is significantly different from the system of the present invention. The first importance difference is that in Patel, the technique used for the execution of Java™ bytecode is bytecode translation, not direct execution as in the system of the present invention. The “Java accelerator” in Patel is only a unit that converts Java™ bytecodes to native instructions, and therefore converts stack-based instructions into register-based instructions. Basically, it interprets in hardware the Java instructions in a series of microcodes that the machine executes natively. The system of the present invention benefits from the advantages of the stack architecture, which provide scalability and predictability. Another difference is the cache subsystem, the system 1 benefiting from an improved cache architecture that includes an object cache and a stack cache under stack core control.

Turning back to FIG. 1, the computing multi-core system 1 includes three primary processor areas. The first is a context area 500, which contains an array of stack cores 501. The number of stack cores 501 depends on the needs of the application running on the system. The second processor area is a storage area 300, which contains expensive shared resources such as an object cache 303, a stack cache 302, and interpretation resources 301. These shared resources can be scaled by the size of the caches, depending on the needs of the running application. The third processor area is an execution area 700, which contains multiple specific execution units. The execution units can be scaled by number and type, again, depending on the needs of the running application. The shared resources include all kinds of resources shared by the stack cores 501, including those from both the storage area 300 and the execution area 700.

The system 1 also includes plural interconnecting networks 200, 400, 600. Each interconnecting network 200, 400, 600 is a point-to-multipoint connector implemented using a network of multiplexors, which establishes a connection between each stack core 501 from the context area 500 and each shared resource from the storage area 300 and execution area 700. (Buses or other communication pathways are shown at 10, 20, 30, 40, 50, 60, 70, and 90.) For each shared resource, the interconnecting networks 200, 400, 600 contain an election mechanism. When more than one single stack core 501 requires access to a target shared resource, the election mechanism of the interconnecting networks 400, 600 will select a stack core 501 to gain access to the target shared resource. If the stack core 501 indicated by a signal currentPrivilegedStream 80 has a valid request to the target shared resource, it will be selected by the election mechanism. On the other hand, if the stack core 501 indicated by the signal currentPrivilegedStream 80 does not have a valid request to the target shared resource, then the election mechanism arbitrarily selects another stack core 501 that has a valid request for the target shared resource.

The interconnect network IN1 400 is used by each stack core 501 from the context area 500 to access each shared resource from the storage area 300. The interconnect network IN2 600 is used by each stack core 501 from the context area 500 to access each shared resource from execution area 700. Use of the interconnect networks 400, 600 is the most efficient way to connect an array of stack cores 501 with shared resources. Additional examples of how stack cores 501 can be connected with shared resources are disclosed in U.S. Pat. No. 6,560,629 B1 entitled “MULTI-THREAD PROCESSING,” issued Oct. 30, 1998 to Harris, which is incorporated by reference herein in its entirety.

A pure OOL processing engine includes hardware support to fetch, decode, and execute a pure OOL instructions stream. In a preferred embodiment, each stack core 501 processes or otherwise supports an individual pure OOL instructions stream. Because the current implementation relates to Java™/.Net™ processing engine, each instruction stream is associated with a Java™/.Net™ thread.

FIG. 2 shows one of the stack core units 501 in more detail. The stack core unit 501 includes a fetch unit 510, which is used to fetch instructions and load/store data from/to the object cache unit 303, e.g., over a bus 50. The fetch unit 510 is operably connected to a decode unit 570 over a bus 511. The decode unit 570 includes a simple instructions controller 520, a complex instructions controller 530, and a pad composer 540 connected to the two instructions controllers 520, 530 by a bus 512. The simple instructions controller 520 is used to decode the most frequently used instructions. The complex instructions controller 530 is used to dispatch complex instructions into the shared interpretation resources in the storage area. The pad composer 540 is used to calculate the stack read/write indexes for the decoded instructions.

The pad composer 540 is operably connected to a stack dribbling unit 550 over a bus 513. The stack dribbling unit 550 contains a hardware stack that caches the local variables array, method frame, and stack operands, and manages the method invocation and the return from a method. The stack dribbling unit 550 also contains an internal execution unit composed of a simple integer unit and a branch unit. The integer unit is simple, and therefore has a small size. It is considered more efficient not to share it in the execution area 700. A more complex integer unit 704, which contains the multiply/divide operations, is located in the execution area 700, but it is an optional unit. The floating point unit 701 in the execution area is also optional. Both units may be included in the system/processor 1 for performance reasons. One suitable stack dribbling unit 550 is disclosed in more detail in U.S. Pat. No. 6,021,469 entitled “HARDWARE VIRTUAL MACHINE INSTRUCTION PROCESSOR,” issued Jan. 23, 1997 to Tremblay et al., which is incorporated by reference herein in its entirety.

The stack dribbling unit 550 is operably connected to a background unit 560 by a bus 514. The background unit 560 commands the read/write operation of parts of the local hardware stack (i.e., the hardware stack of the stack dribbling unit 550) to the stack cache unit 302 in the storage area 300, the stack cache 302 therefore being a continuation of the stack dribbling unit hardware stack. The background unit 560 issues the read/write request in the background, which avoids wasting any CPU cycles.

The stack dribbling unit 550 is operably connected to the background unit 560 by a bus 514. The background unit 560 commands the read/write operation of parts of the local hardware stack (i.e., the hardware stack of the stack dribbling unit 550) to the stack cache unit 302 in the storage area 300; the stack cache unit 302 therefore is a continuation of the stack dribbling unit hardware stack. The background unit 560 issues the read/write request in the background, which avoids wasting any CPU cycles. This unit is called a ‘background unit’ because the read/write requests to the stack cache unit 302 are issued independent of the CPU's normal operation, therefore not wasting any CPU cycles.

Each instruction stream running on a stack core 501 is directly associated with a software thread. Software threads might be a pure OOL (Java™ or a .Net™) thread. All software attributes (status, priority, context, etc.) of a thread become attributes of the stack core 501.

The fetch unit 510 fetches one cache line at a time from the object cache unit 303 and passes it to the decode unit 570. The cache line can be of any size. In one embodiment of the system 1, the cache line is 32 bytes wide, but it can be scaled to any value. The fetch unit also includes the load store unit; therefore, the load store unit is not shared. This is because the load/store bytecodes are frequently used and the area overhead is minimum.

The fetch unit 510 also pre-decodes the instructions to obtain the instruction type. The instruction type can be either simple or complex. If the instruction is one of the most common and simple, it is dispatched to the simple instructions controller 520. Otherwise, if it is a complex or infrequently used instruction it is dispatched to the complex instructions controller 530. In order to decode these kinds of instructions, the complex instructions controller sends a request to the interpretation resources 301. The result of this request is placed on the bus 50. Also, the complex instructions controller 530 handles the exceptions thrown from the units contained in the execution area 700.

Switching from one pure OOL instruction set to another (for example from Java™ to .Net™) requires the replacement of the simple instructions controller 520 and interpretation resources 301.

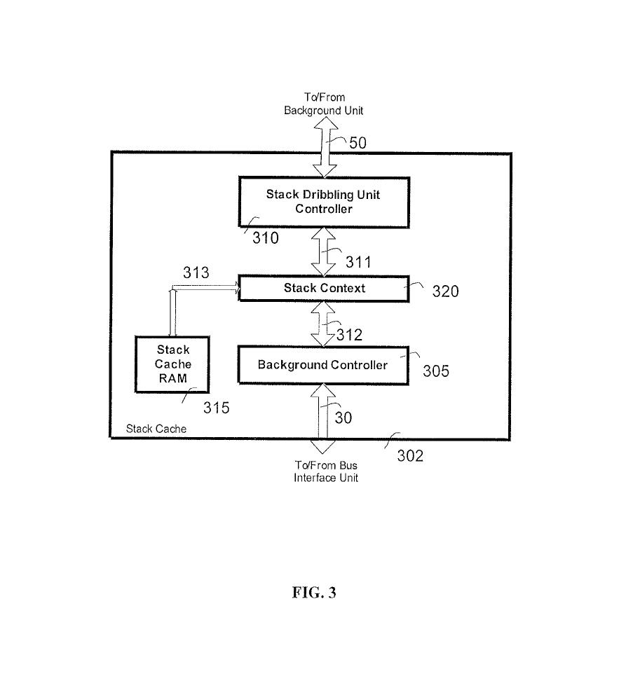

FIG. 3 shows the architecture of the stack cache unit 302, which is used to store the data evicted from each stack core's own hardware stack, due to the multiple calls of methods, and to fill each stack core's hardware stack in case of multiple returns from methods. The stack cache is therefore a continuation of each stack core's hardware stack. The stack cache unit 302 includes a stack dribbling unit controller 310, a stack context 320, a background controller 305, and stack cache RAM 315, which are operably interconnected by buses 311, 312, 313 as shown in FIG. 3. The stack dribbling unit controller 310 receives normal or burst read/write commands from the background unit located in each stack core's stack dribbling unit, through bus 50. The stack context 320 holds thread information (e.g., the stack tail located in main memory) and information about the number of elements in the stack cache RAM 315. It also performs thresholds checks, for the situation where it must evict data from the stack cache RAM 315 to the main memory or when it must bring new data from the main memory in case of multiple returns. The eviction situation appears when the high threshold limit is reached and stack elements are transferred from the stack cache RAM 315 to the main memory. This happens for example in case of multiple calls of methods. When the low threshold limit is reached, new elements are transferred from main memory to the stack cache RAM 315. An example of reaching the low threshold, and therefore bringing new elements to the stack cache RAM 315, happens in the case of multiple returns. The background controller 305 issues the read/write requests to the bus interface unit 100 for bringing new elements and for the eviction of old elements to/from the main memory. The background controller 305 also supports the burst read/write mode. An important feature of the stack cache unit 302 is that it performs most of its operations in background, therefore not wasting CPU time for fill/spill operations. Due to the stack cache architecture, the data flow from each stack core's hardware stack to the main memory is maintained at a lower rate, and the penalty is minimized. The stack cache unit 302 behaves like a buffer between each stack core's hardware stack and the main memory.

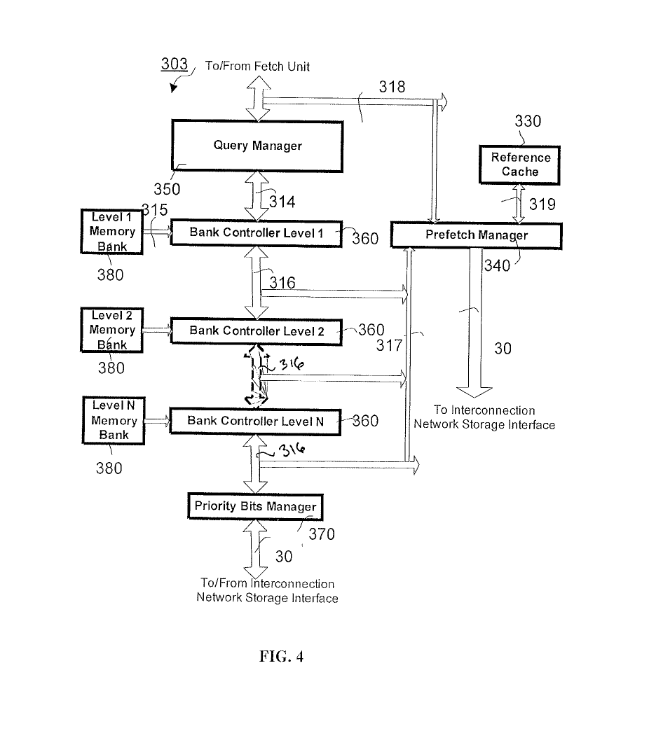

FIG. 4 shows the object cache unit 303, which is used to store entire small objects or methods, or parts of large objects or methods. The object cache unit 303 contains a query manager 350, a scalable number of bank controllers 360 with the same number of corresponding memory banks 380, a pre-fetch manager 340, a reference cache 330, and a priority bits manager 370, which are operably interconnected by buses 314, 316, 317, 318, etc. as shown in FIG. 4. The multi-level cache architecture improves the current's subsystem autonomy. For example, in the case where a cache hit occurs on memory bank level 1, the bank controller level 2 can further issue pre-fetch commands to the pre-fetch manager without wasting any CPU cycles. The memory banks have the same width and can store any type of vector, such as object fields and class methods. When one requested object enters the memory bank, the pre-fetch manager knows which fields of the object are references, based on information bits added by the priority bits manager 370, enabling it to pre-fetch those objects too. The same will happen with methods.

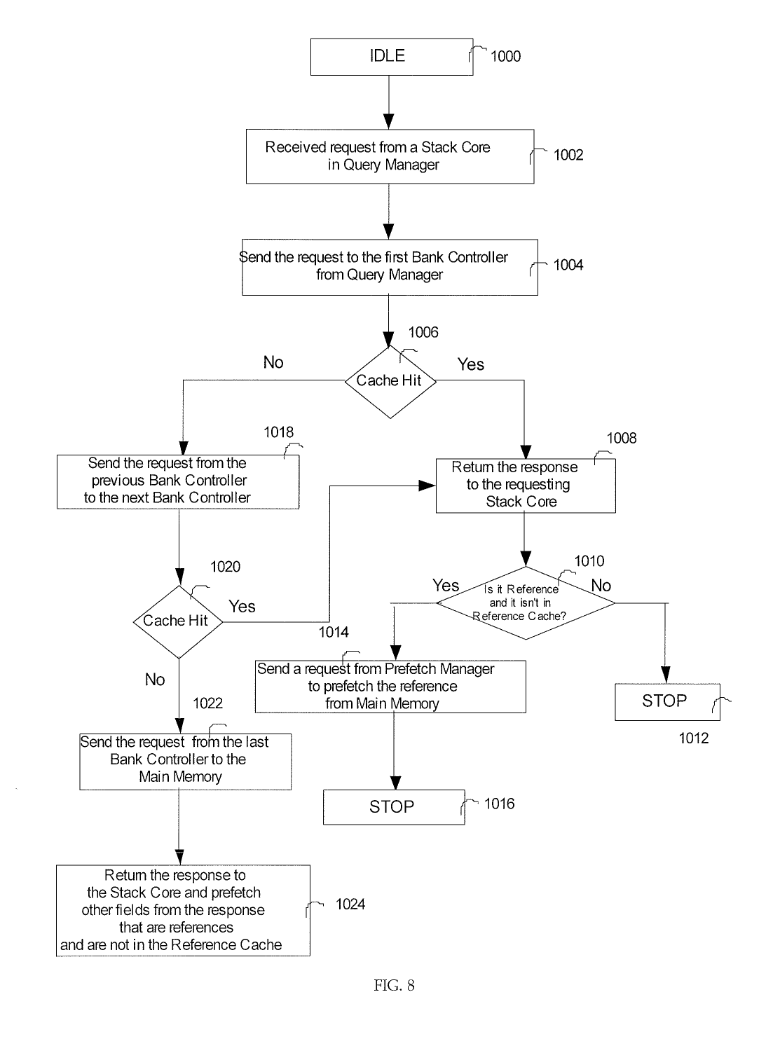

The pre-fetch mechanism works in two ways. The first mode of operation is when a cache hit occurs and the pre-fetch manager checks if the requested data is a high priority reference (see the section above as relating to the priority bits manager). If so, the pre-fetch manager will also pre-fetch data from that location of memory. The second mode of operation is in the case of a cache miss. Here, the priority bits manager appends two bits to each element of the requested data. After that, the pre-fetch manager decides which are the references with the highest priority to be pre-fetched, checks to see if they are in the reference cache, and if not, it pre-fetches them from the main memory. A diagram of this mode of operation is presented in FIG. 8, which is referred to herein as a “memory bank request.” While executing code in a method, the bank controller 360 can pre-fetch the next block of the method, if it is a large method, or other methods of the same object, that could be needed in the shortcoming period. The bank controller 360 can perform data and method pre-fetch in parallel with the normal operation. Accordingly, the data the processor will encounter in the program will already be in the cache, thus ensuring a higher hit rate. The priority bits manager 370 adds the information bits to the fields contained in the block brought from the main memory.

As shown in FIG. 8, at Step 1000, the object cache unit 303 is idle. At Step 1002, the query manager 350 receives a request from a stack core 501. At Step 1004, the request is sent to the first bank controller 360 (e.g., bank controller level 1) from the query manager 350. In the case of a cache hit, as at Step 1006, a response is returned to the requesting stack core, at Step 1008. At Step 1010, it is determined if the request is for a high priority reference that is not in the reference cache. If not (i.e., either not a high priority reference, or a high priority reference already in the reference cache), the process stops at Step 1012. If so, the pre-fetch manager sends a request to pre-fetch the reference from main memory, as at Step 1014, with the process subsequently ending at Step 1016. In the case of a cache miss, as at Step 1006, the request is sent from the previous bank controller (e.g., bank controller level 1) to the next bank controller (e.g., bank controller level 2). See Step 1018. If there is a cache hit, as determined at Step 1020, the process continues at Step 1008, as above. In not, the request is sent from the last bank controller to the main memory, as at Step 1022. The process ends at Step 1024, where the response is returned to the stack core. Additionally, the unit pre-fetches other fields from the response that are priority references not in the reference cache.

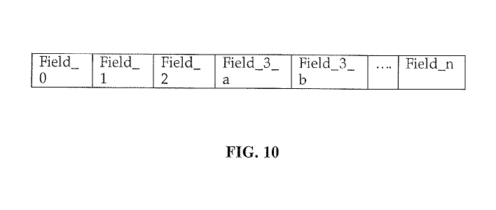

The heap area is the area in memory where objects are allocated dynamically during runtime when executing (i) the new instruction and (ii) arrays, generated in the current implementation by the Java™ instructions: newarray, anewarray, or multianewarray. The structure of object records in the heap area is presented in FIG. 10, wherein:
n is the number of 32 bit entries of the object record;
field_{—}0—is always a 32 bit signed integer value corresponding to: the 3 most significant bits compose the type of the structure, the following 7 bits are the reference bits of the first part of the object, and the following bit are the field size in class Object, and has the value of the total size of the object (excluding field_{—}0);
field_{—}1—is always a 32 bit reference to the object class, located in CLASS AREA; and
field_n—is a 32 bits value which can be:
   a 32 bits reference (if the field is a reference);
   a 32 bits signed value if the field is boolean, byte, short, integer or float;
   half of a 64 bits signed value if the field is long or double.

The object cache unit 303 is based on the data organization in memory. Every data structure is treated like an object. As a generalization, any object/method/methodTable etc. can be treated like a vector. The object record is a vector containing memory lines with the following structure: 256 bits wide and divided in 8 words (8*32 bits), but it can be scaled to store any number of 32 bit words. An 8 words configuration is chosen in one embodiment of the system 1 because statistically a large percentage of Java™ objects/methods are smaller than 256 bits.

As noted above, the object cache unit 303 contains the following major blocks: the memory banks 380, which contain the object/method cache lines; the bank controller 360, which manages all the operations with the memory bank; the query manager 350, which decodes all the requests from each stack core's fetch unit and drives them through the bank controller to the memory bank; the reference cache 330, which is a mirror of the cache, containing only the references that are stored in the cache to avoid pre-fetching already cached data; the pre-fetch manager 340, which decides what data needs to be pre-fetched based on software priorities; and the priority bits manager 370, which adds information bits to requested data.

The object cache unit 303 is in effect a vector cache, because all the cache lines are vectors. The size of the cache line is not relevant, because the cache lines can be of any size, tuned for the needs of the application. In one embodiment of the system 1, based on simulations of object sizes, a cache line containing 8 elements*32 bits is utilized. If the object is larger than 8 words, only the first 8 words will be cached. When a non-cached field is requested, the part of the object that contains that field is cached. Every element can be a reference to another vector of elements. Based on this fact, a smart pre-fetch mechanism can have a strong impact in reducing the miss rate.

Regarding the query manager 350, because of the special organization of objects, classes, and methods in the system 1, any request to the object cache 303 is broken into a number of sequential memory bank 380 requests. The query manager 350 is in effect a shared decoder that has two major roles: to decode a request to the object cache 380 into specific memory bank requests, and arbiter the use of the decoder. The arbitration is made between the requests issued by a core at a given time and the bank controller that responds to the query manager with requested data. The specific memory bank requests are in fact the number of steps necessary to obtain the requested data. For example, in the particular Java™ CPU implementation used in the system 1, the instructions related to objects, and therefore, memory access instructions, are: 1) getfield/getstatic; 2) putfield/putstatic; and 3) invokevirtual/invokestatic/invokeinterface/invokespecial.

Operation of the query manager 350 will now be demonstrated, based on the memory organization described herein, by the execution of two of the most commonly used memory access instructions in a pure OOL, e.g., Java™.

The first is getfield. The getfield instruction is the JVM instruction that returns a field from a given object. The getfield instruction is followed by two 8-bit operands. Before the execution of getfield, the objectReference will be on the top of the operand stack. The value is popped from the operand stack and is sent to the object cache along with the 16-bit field index. The objectReference+fieldIndex address in main memory represents the requested field. An example of operation of the cache subsystem for a memory bank request is represented in FIG. 8. The getfield instruction is implemented using a single memory bank request on the address objectReference+fieldIndex.

The second most used memory access instruction is invokevirtual, which is similar to an instruction that calls a function. As in the example of the getfield instruction, the invokevirtual opcode is followed by the objectReference and, because it is a call of a method, by the number of arguments of the method. The objectReference is popped from the operand stack and a request is sent to the query manager 350 with the objectReference address and the 16-bit index. The query manager transforms the request in a sequence of memory bank sequential requests. In the first query, it requests the class file. The reference to each object's class file is located in the second position of the object record vector. The size of the vector is located in the first position of each record. After the query manager receives the class file, it requests the method table of the given class, in which it can find the requested method. Associated with each class is a method table reference. The query manager sends a request at methodTable reference+methodId to get the part of the method table that contains a reference to the requested method. After that, the query manager sends a request on the methodReference address to get the effective method code stored in main memory. Because the length of each of the vast majority of the Java™ methods is below 32 bytes, statistically speaking, the 32 byte cache line is the most efficient.

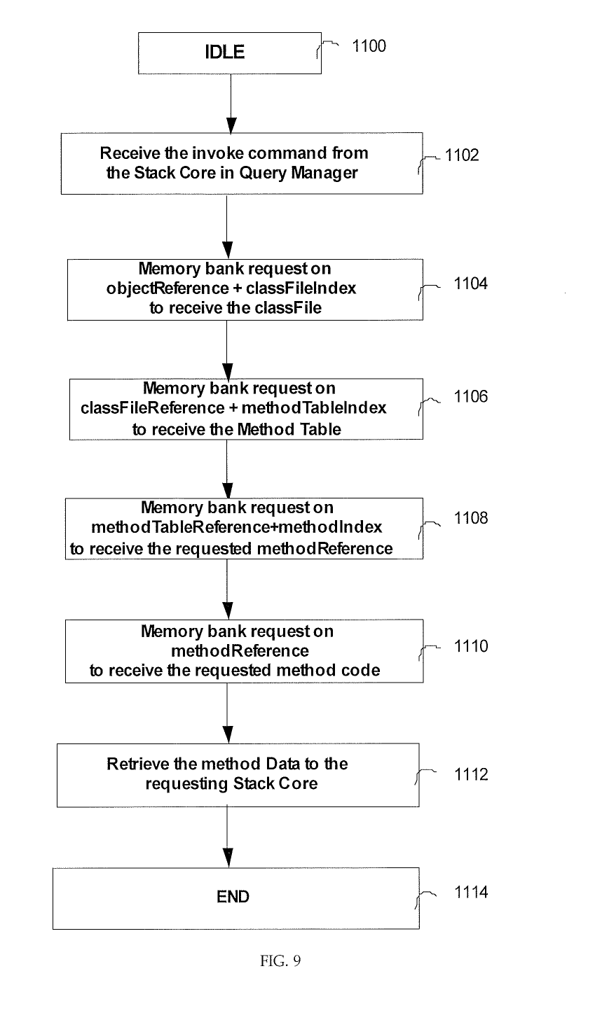

A diagram that explains the execution of the invokevirtual instruction from the perspective of the object cache, based on the memory bank request in FIG. 8, is presented in FIG. 9. Here, at Step 1100, the object cache unit 303 is idle. At Step 1102, the query manager 350 receives the invoke command from a stack core. The query manager 350 then transforms the request in a sequence of memory bank sequential requests. In the first query, at Step 1104, it requests the class file from the memory bank. After the query manager receives the class file 350, it requests the method table reference of the given class, by issuing a request on the class file reference+method table index as at Step 1106. Associated with each class is a method table reference. At Step 1108, the query manager 350 then sends a request at methodTable reference+methodIndex to get the requested methodReference. After that, at Step 1110, the query manager sends a request on the methodReference address to get the effective method code stored in main memory. After that, at step 1112 the query manager retrieves the method code to the requesting stack and the process ends at Step 1114.

Each bank controller 360 contains all of the logic necessary to grant the access of the request buses or response buses to a single resource, namely, a memory bank 380. Access to the memory bank 380 is controlled by a complex FSM. The bank controller 360 also sends requests to the following bank controller in case of a cache miss.

Each memory bank 380 is a unit that contains the cache memory, which stores vector lines, a simple mechanism that determines a hit or a miss response to a request made by the bank controller 360, the necessary logic to control the organization of the data lines in the cache, and the eviction mechanism. A cache line contains any number of 32 bit elements. In one embodiment of the system 1, the cache line contains 8 element vectors and information bits for each word. The information bits are added by the priority bits manager. In effect, each memory bank is an N-way cache that can support a write-through, write-back, or no-write allocation policy.

The pre-fetch manager 340 is the unit that has the task of issuing pre-fetch requests. The information bits attached to a cache line indicate whether a word is a reference to another vector, and confer information of how often the reference is used. The pre-fetch manager 340 monitors all the buses 316 between the bank controllers 360, the bus 316 between the last bank controller 360 and the priority bits manager 370, and the bus 50 from query manager 350 to the context area 500. Based on the information bits attached to the cache line, the pre-fetch mechanism determines the next reference/references that will be used, or if another part of the current vector will be used. When such a reference is found, a request to the reference cache is made. If the reference is not contained in the reference cache, a request is made to the main memory in order to obtain the requested data. An example of this process is represented in FIG. 8.

The pre-fetch manager mechanism can be configured from software by an extended bytecode instruction. If in one instruction stream there are long methods, the pre-fetch mechanism is configured to pre-fetch the second part of the method. If in one instruction stream there are many switches between objects, the pre-fetch mechanism can be configured to pre-fetch object references based on priorities. Therefore, the pre-fetch mechanism of the system/processor 1 is a very flexible, software configurable mechanism.

Although the pre-fetch manager mechanism 340 appears similar to that of Matthew L. Seidl et al.'s “Method and apparatus for pre-fetching objects into an object cache” (hereinafter, “Seidl”), it is fundamentally different. In particular, the only pre-fetch mechanism in Seidl is for object fields. According to a preferred embodiment of the present invention, the pre-fetch mechanism can be dynamically selected between the pre-fetch of object fields, the pre-fetch of methods, the pre-fetch of method tables, the pre-fetch of the next piece of the method, etc., or all of these mechanisms combined, depending on the nature of the application.

The reference cache 330 is a mirror for all the references that are contained in the memory banks 380. The main role of this unit is to accelerate the pre-fetch mechanism, because the pre-fetch manager 340 has a dedicated bus to search a reference in the cache. The fact that the reference cache 330 is separated from the memory banks 380 maintains a high level of cache bandwidth for normal operations, unlike the pre-fetch mechanism presented in the Seidl reference. This separate memory allows the pre-fetch mechanism to run efficiently, by not wasting CPU cycles for its operation.

The priority bits manager 370 contains a simple encoder that sets the information bits for each vector. It adds pre-fetch bits to the reference vectors (allocated by the anewarray instruction) and method table, because, in this case, besides the size, all other fields are references. Each word in cache will have 2 priority bits associated with it, as follows: (i) 00—not reference; (ii) 01—non pre-fetch-able reference; (iii) 10—reference with low pre-fetch priority; and (iv) 11—reference with high pre-fetch priority.

FIG. 5 shows the thread priority management mechanism located in the thread synchronization unit 703. This unit is used to control the synchronization between the instructions streams. The thread priority management mechanism contains a set of registers 710 that can be programmed by the application layer with the priority assigned for each instruction stream. Each instruction stream can be assigned to a Java™/.Net™ thread, therefore, these priorities can have the same range and meaning as the Java™/.Net™ threads.

The selector 720, operably connected to the set of registers 710 by a bus 711, selects the priority of the current instruction stream, which is multiplied with a constant and loaded into an up/down counter 730 that is set to count down. When the up/down counter 730 reach the zero value, this will increment a stream counter 740. The stream counter 740 is initialized with a 0 value at reset. Using an incrementer 750, the selector 720 is able to feed the up/down counter 730 with the priority of the next instruction stream. The signal currentPrivilegedStream 80 continuously indicates which is the instruction stream that has to be elected if there is more than one instruction stream requesting access to a shared resource. This mechanism is based on the supposition that by using a higher value for a priority of an instruction stream “A,” the currentPrivilegedStream will indicate that the instruction stream A is the stream with the higher priority for a longer period of time than an instruction stream “B” that has a lower value of priority. Therefore, the instruction stream A has more chances to be elected more often than instruction stream B.

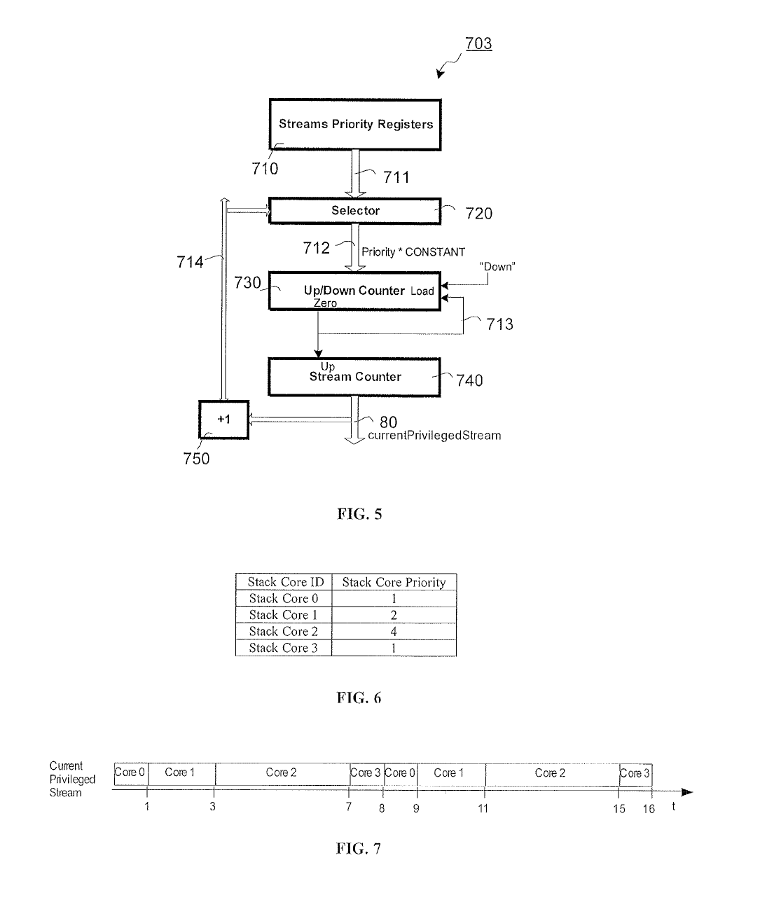

An example of this operation is presented in FIGS. 6 and 7. The table from FIG. 6 represents an example of four stack cores with their instruction stream priorities. FIG. 7 shows a timeline that represents the currentPrivilegedStream signal over a period of time. As indicated, because stack core 3 has the highest priority, it is chosen to be the currentPrivilegedStream for the longest time. If, for example, the instruction stream running on stack core 1 and the instruction stream running on stack core 2 make a request in the same clock cycle to the interconnection networks, during the time period when the instruction stream of stack core 3 is the currentPrivilegedStream, the requested interconnection network arbitrarily elects one of the two instruction streams. Otherwise, if the instruction stream of stack core 1 and the one of stack core 3 make a request in the same clock cycle to the interconnection networks, in the period of time that the instruction stream of stack core 3 is the currentPrivilegedStream, the requested interconnection network elects stack core 3's instruction stream to make the request.

One embodiment of the invention can be characterized as a processor system that includes a context area, a storage area, and an execution area. The context area includes a plurality of stack cores, each of which is a processing element that includes only simple processing resources. By “simple” processing resources, it is meant “the resources that bring a small area overhead and are very frequently used (e.g., integer unit, branch unit). The storage area is interfaced with the context area through a first interconnection network. The storage area includes an object cache unit and a stack cache unit. The object cache pre-fetches and stores entire objects and/or parts of objects from a memory area of the processor system. The stack cache includes a buffer that supplements the internal stack capacity of the context area. The stack cache pre-fetches stack elements from the processor system memory. The execution area is interfaced with the context area through a second interconnection network, and includes one or more execution units, e.g., complex execution units such as a floating point unit or a multiply unit. The execution area and storage area are shared among all the stack cores through the interconnection networks. For this purpose, the interconnection networks include one or more election mechanisms for managing stack core access to the shared execution area and storage area resources.

Another embodiment of the invention is characterized as a processor system that includes a plurality of stack core processing elements, each of which processes a separate instruction stream. Each stack core includes a fetch unit, a decode unit, context management resources, a hardware stack, a simple integer unit, and a branch unit. The stack cores lack complex execution units. As should be appreciated from the above, by “complex” execution units, it is meant “units” that are large in term of area and that are infrequently used (e.g. floating point unit, multiply/divide unit).

In another embodiment, the stack cores are integrated in a processor context area. The processor system additionally includes a storage area (which itself includes an object cache and a stack cache), an execution area with one or more execution units, e.g., complex execution units, and one or more interconnection networks that interconnect the context area with the storage area and the execution area. The resources of the storage area and the execution area are shared by all the stack cores in the context area.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the above disclosure.

What is claimed is:

1. A processor system comprising:
a context area having a plurality of stack cores, each of said stack cores comprising a processing element that includes only simple processing resources;
a storage area interfaced with the context area through a first interconnection network, said storage area including an object cache unit and a stack cache unit, wherein the object cache pre-fetches and stores entire objects and/or parts of objects from a memory area of the processor system, and wherein the stack cache comprises a buffer that supplements an internal stack capacity of the context area, said stack cache pre-fetching stack elements from the processor system memory; and
an execution area interfaced with the context area through a second interconnection network, said execution area having one or more execution units;
wherein the execution area and storage area are shared among the stack cores of the context area through the interconnection networks, said interconnection networks including election mechanisms for managing stack core access to shared execution area and storage area resources.

2. The processor system of claim 1, wherein:
the simple processing resources of each stack unit include a fetch unit, a decode unit, context management resources, a simple integer unit, and a branch unit; and
the stack units lack floating point units, multiply units, and other complex execution units.

3. The processor system of claim 2, wherein the execution area includes complex execution units shared by the stack cores of the context area, said complex execution units including a floating point unit, a multiply unit, and a thread synchronization unit that controls synchronization between instruction streams in the processor system.

4. The processor system of claim 1, wherein each stack core includes a control structure and a local data store for processing an instruction stream, said instruction stream being associated with a software thread executed by the processor system.

5. The processor system of claim 4, wherein each stack core comprises:
a fetch unit interfaced with the object cache unit for fetching instructions from the object cache unit and for data transfer between the fetch unit and object cache unit;
a decode unit interfaced with the fetch unit, said decode unit including a simple instructions controller that decodes simple instructions, a complex instructions controller that decodes complex instructions, and a pad composer connected to the two instructions controllers that calculates stack read/write indexes for the decoded instructions;
a stack dribbling unit interfaced with the decode unit, said stack dribbling unit having a hardware stack that caches a local variables array, a method frame, and stack operands, wherein the stack dribbling unit manages method invocation and returns from a method; and
a background unit interfaced with the stack dribbling unit for commanding read/write operations between the stack dribbling unit hardware stack and the stack cache unit of the storage area.

6. The processor system of claim 5, wherein the fetch unit of each stack core pre-decodes the instructions fetched from the object cache unit to obtain respective instruction types thereof, for determining whether to send the instructions to the simple instructions controller or the complex instructions controller.

7. The processor system of claim 5, wherein:
the storage area further includes interpretation resources shared by the stack cores; and
the complex instructions controller of each stack core decode unit accesses the interpretation resources of the storage area for decoding complex instructions.

8. The processor system of claim 1, wherein the storage area further includes interpretation resources, shared by all the stack cores, for use in decoding complex instructions.

9. A processor system comprising:
a plurality of stack core processing elements each for processing a separate instruction stream,
wherein each of the stack cores includes a fetch unit, a decode unit, context management resources, a hardware stack, a simple integer unit, and a branch unit,
and wherein each stack core lacks any complex execution units.

10. The processor system of claim 9, wherein:
the plurality of stack cores are integrated in a processor context area; and
the processor system further comprises:
a storage area having an object cache and a stack cache;
an execution area having one or more execution units; and
at least one interconnection network interconnecting the context area with the storage area and the execution area;
wherein the resources of the storage area and the execution area are shared by all the stack cores in the context area.

11. The processor system of claim 10, wherein the storage area further includes interpretation resources that are shared among the plurality of stack cores, said interpretation resources being used by the stack cores to decode complex instructions in the processor system.

12. The processor system of claim 11, wherein each stack core is configured to run complex pure OOL instructions through the shared interpretation resources of the storage area; and
wherein non OOL code can also be executed with the help of a compiler.

13. The processor system of claim 10, wherein:
each stack core is configured to decode simple instructions; and
resources for decoding complex instructions are shared among the plurality of stack cores.

14. The processor system of claim 10, further comprising:
a first interconnection network interconnecting the context area with the storage area;
a second interconnection network interconnecting the context area with the execution area; and
at least one election mechanism interfaced with the interconnection networks for managing stack core access to shared resources of the execution area and storage area.

15. The processor system of claim 14, wherein operation of the election mechanism, for managing stack core access to shared resources of the execution area and storage area, is based at least in part on priority levels assigned to the instruction streams running on the stack cores.

16. The processor system of claim 15, wherein the election mechanism comprises a thread synchronization unit located in the execution area, said thread synchronization unit storing the priority levels of the instruction streams, and wherein the thread synchronization unit transmits at least one control signal to the interconnection networks for identifying the instruction stream that has the highest priority level among the instruction streams running on the stack cores, when a shared resource of the execution area or storage area is concurrently requested by more than one of the plurality of stack cores.

17. The processor system of claim 10, wherein:
the instruction stream processed by each stack core is associated with an independent software thread; and
for each software thread, the software attributes of the software thread become attributes of the stack core on which software thread is running.

18. The processor system of claim 10, wherein each stack core includes a simple instructions controller for running simple pure OOL instructions.

19. The processor system of claim 10, wherein each stack core includes a background unit that issues read/write requests to the stack cache in the background unit for the handling of stack fill/spill, thereby avoiding wasting CPU cycles.

20. A processor system comprising:
a plurality of stack cores each for processing a software thread, wherein each of the stack cores includes a hardware stack;
a storage area having a stack cache that stores data continuations of the hardware stacks of the stack cores, and an object cache that stores objects and methods, said object cache comprising a query manager, a plurality of chained bank controllers each having a memory bank, a pre-fetch manager, and a priority bits manager, which are all interconnected by one or more buses;
wherein the query manager receives requests from any of the stack cores, transforms the requests into memory bank requests, and issues them to a first of said bank controllers, said first bank controller sending the requests to a second of said bank controllers;
wherein each of the second and subsequently chained bank controllers receives the requests from the bank controller preceding it in the chain of bank controllers and sends the requests to the next bank controller in the chain of bank controllers; and
wherein the priority bits manager adds pre-fetch information to any structure brought from a bus interface unit portion of the processor system, for helping the pre-fetch manager in pre-fetching data designated as having a high priority level.

21. The processor system of claim 20, wherein each bank controller pre-fetches methods and data based on the pre-fetch information added by the priority bits manager.

22. The processor system of claim 21, wherein each of the bank controllers is configured to issue pre-fetch commands autonomously.

23. The processor system of claim 20, wherein:
the stack cores are integrated in a context area; and
the pre-fetch manager monitors (i) buses between the bank controllers and (ii) a bus between the query manager and the context area.

24. The processor system of claim 20, wherein the object cache further comprises a reference cache interfaced with the pre-fetch manager, said pre-fetch manager querying the reference cache for every pre-fetch operation to verify if a reference scheduled for pre-fetch is already in the object cache.
